(19) United States
(12) Patent Application Publication
(10) Pub. No.: US 2006/0019158 A1
(43) Pub. Date: Jan. 26, 2006

(54) Battery having a collector plate

(75) Inventors: Kazuteru Mori, Minamiawaji-shi (JP); Hiroyuki Inoue, Minamiawaji-shi (JP); Kazuki Shimozono, Sumoto-shi (JP); Kazuo Tomimoto, Minamiawaji-shi (JP); Kei Tomihara, Sumoto-shi (JP); Hiroshi Fukuda, Naruto-shi (JP); Yoshihiro Tobita, Minamiawaji-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Sanyo Electric Co., Ltd., Moriguchi-shi (JP)

(21) Appl. No.: 11/183,842

(22) Filed: Jul. 19, 2005

(30) Foreign Application Priority Data
Jul. 21, 2004 (JP) 2004-213567

(51) Int. Cl. H01M 2/08; H01M 2/26

(52) U.S. Cl. 429/174; 429/161; 429/181

(57) ABSTRACT

To provide a battery with low internal resistance and high efficiency in which connection points to a collector plate are evenly distributed on the electrode plate and the number of the connection points is increasable, a battery according to the present invention includes a positive and negative collector plates respectively connected to end surfaces of an electrode assembly. The collector plate, connected to a positive electrode plate, includes a connection area connecting to an edge of the positive electrode plate, and a lead area extended from an outer edge of the connection area. Flange structures, by which the positive and negative electrode plates are connected, are included in the connection area. The flange structures include a ring-shaped flange structure, a linear flange structure, and semi-ring shaped flange structure and semi ring-shaped inner flange structure respectively formed on outer and inner edges of the connection area.

### BACKGROUND OF THE INVENTION

(1) Field of the Invention

The present invention relates to a battery having a collector plate, and more specifically relates to a structure of the same for connecting an electrode assembly to the collector plate.

(2) Description of the Related Art

In recent years, alkaline secondary batteries, such as nickel-cadmium batteries and nickel-hydrogen batteries, and nonaqueous secondary batteries, such as lithium-ion batteries, have become common with the widespread use of portable phones, PDAs (Personal Digital Assistants), electric tools, and so on. For instance, a secondary battery has a structure in which an electrode assembly is housed in a cylindrical casing can, and an opening in the casing can is sealed by a seal cover. A collector plate, a collector lead or the like is connected to each of a positive electrode plate and a negative electrode plate included in the electrode assembly. The positive electrode plate and the negative electrode plate are connected to the seal cover, the casing can, a battery terminal, and so on via the collector plate, the collector lead, and so on.

By the way, to improve the efficiency of the power collection performed by both positive and negative electrode plates, the collector plate is more commonly used for the batteries for devices that use a large current, such as electric tools, than the collector lead. This is because if the collector lead is used, the internal resistance becomes high due to a paucity of connection paths to each electrode plate. On the other hand, the collector plate is connected to a plurality of points on the edge of each electrode plate that is placed on an end surface of the electrode assembly. Therefore the collector plate can reduce the internal resistance. Techniques relating to such a collector plate are, for instance, disclosed by Japanese Laid-open Patent Application No. 2000-331667 and Japanese Examined Utility Model Registration No. 61-34695. In these documents, a collector plate with connection area that is subjected to so-called flanging is used. The flanging is performed for forming rims (flanges) that project toward the electrode assembly. The documents disclose techniques for surely connecting such a collector plate to the edge of each electrode plate via the rims (flanges).

However, in the conventional techniques, such as those disclosed in the above-described documents, connection-points between the collector plate and the electrode plate are unevenly distributed in terms of the longitudinal direction of the electrode plate. Therefore, it is difficult to efficiently perform inputs and outputs of electricity. For instance, in the collector plate disclosed by the above-described Japanese Laid-open Patent Application No. 2000-331667, four linear flange structures, which are used for connecting the collector plate to the electrode plates, are formed so as to radiate from the center point of the connection area. The pitch between adjoining connection points, measured in the longitudinal direction of the electrode, is larger at the outer circumference than at the inner circumference, because the length of the outer circumference is larger than the length of the inner circumference. Also, the manufacturing process for forming flange structures arranged in a cross-shape is complicated. Further, the strength of the collector plate material might be deteriorated, because the flange structures are formed so as to be arranged in the direction that intersects with the direction that the production line of the material flows.

In the collector plate disclosed by the above-described Japanese Examined Utility Model Registration NO. 61-34695, a plurality of ring-shaped flange structures are used for connecting the collector plate to the electrode plates. In such a collector plate having ring-shaped flange structures, a certain distance is required between adjoining ring-shaped flange structures in order to secure the mechanical strength of the collector plate and reduce the electrical resistance. Therefore, the connection points between the collector plate and the electrode plate are unevenly distributed in the longitudinal direction of the electrode plate. Especially, if the electrode assembly is in a spiral shape, there might be no connection point in some regions close to the spiral axis.

Also, regarding the collector plate of the above-described Japanese Examined Utility Model Registration No. 61-34695, not much attention is paid to the layout of the electrode plate and the connection points. Therefore, in the techniques disclosed by the both above-described documents, the connection points between the collector plate and the electrode plate are not evenly distributed in terms of the longitudinal direction of the electrode plate. Those techniques are not satisfying from the viewpoint of reducing the internal resistance of the battery.

### SUMMARY OF THE INVENTION

The present invention is made to solve the above-described problems. The object of the present invention is therefore to provide a battery with high efficiency, low internal resistance, and having connection points to a collector plate, which are evenly distributed on an electrode plate and the number of which is increasable.

The above object is fulfilled by a battery comprising: an electrode assembly that includes a positive electrode plate and a negative electrode plate opposing each other across a separator; a casing that is in a shape of a cylinder with a closed bottom, the electrode assembly being housed in the casing; a seal cover that is placed over an opening of the casing, the opening being sealed by the seal cover; and a collector plate having a connection area and being housed in the casing together with the electrode assembly, wherein the connection area includes flange structures, each having a flange that projects toward the electrode assembly and connecting the collector plate to an edge of the positive electrode plate or an edge of the negative electrode plate, and the flange structures include a ring-shaped flange structure whose flange is formed along an edge of a hole, and a linear flange structure whose flange is formed along edges of a slit.

In this description, the “flange” means a projecting edge of an opening that is provided in each flange structure included in the collector plate.

Here, the above-described ring-shaped flange structure and the linear flange structure respectively have a flange in a closed-ring shape and a flange in an opened-ring shape.

In the battery according to the present invention, the collector plate, which is to be connected to the electrode assembly, has at least two types of flange structures, namely the ring-shaped flange structure and the linear flange structure. Therefore, it is easy to evenly distribute the connection points between the collector plate and one of the electrode plates included in the electrode assembly. In other words, the connection points between the collector plate and the electrode plate can be evenly distributed in the longitudinal direction of the electrode plate by appropriately combining and arranging the ring-shaped flange structure and the linear flange structure. More specifically, the distance between the connection points in the longitudinal direction of the electrode plate becomes not extremely long in any region by forming the linear flange structure. The connection points are evenly distributed in the longitudinal direction of the electrode plate by setting up connection points that is formed by the ring-shaped flange structure between the adjoining connection points that is formed by the linear flange structures.

In addition, the current density between the electrode plate and the collector plate can be equalized by evenly distributing the connection points as described above, and therefore the internal resistance can be decreased. As described above, in the battery according to the present invention, the connection points between the collector plate and the electrode plate are evenly distributed. As a result, many connection points can be secured.

Therefore, the battery according to the present invention can decrease the resistance between the electrode plate and the collector plate, and the battery with low internal resistance and high efficiency can be realized.

Furthermore, with a structure in which a semi ring-shaped flange structures, each having a partially cut out flange, are formed on an outer edge of the connection area in addition to the ring-shaped flange structure and the linear flange structure, the connection points between the collector plate and the electrode plate can be increased. In the battery according to the present invention, having such a structure, the internal resistance can be further decreased and the efficiency can be further improved.

In the case where a through hole is formed on a center of the connection area, a semi ring-shaped inner flange structure having a partially cut out flange may be formed on an edge of the through hole.

Electrode assemblies generally used for batteries are classified into a layered electrode assembly, in which positive electrode plates and negative electrode plates are layered one after the other so as to sandwich separators, and a spiral electrode assembly, in which strap-shaped positive electrode plate and negative electrode plate opposing each other across a separator are spirally wound together. If the battery according to the present invention includes the spiral electrode assembly, the connection area may be formed so as to be circular and correspond in shape to the end surface of the spiral electrode assembly and the collector plate may be connected to the electrode assembly by aligning the center of the connection area with the center of the end surface of the spiral electrode assembly. Also, two or less ring-shaped flange structures may be formed on each concentric circle around a center point of the connection area.

In the battery according to the present invention, the connection points between the collector plate and the electrode plate can be evenly distributed by not forming more three or more ring-shaped flange structures on each concentric circle around the center point of the connection area. In other words, in the spiral electrode assembly, it is possible to form the electrode plate so that the electrode plate appears to be formed on a concentric circle around the winding axis.

With the stated structure, if three or more ring-shaped flange structures are formed on the concentric circle, this means that the connection points between the collector plate and the electrode plate are formed on three or more adjoining areas in the longitudinal direction of the electrode plate (the circumferential direction of the electrode assembly). In terms of the electric resistance and the structural strength, a certain distance is required between ring-shaped flange structures on the collector plate. Other ring-shaped flange structures have to be formed away from the three or more ring-shaped flange structures formed on the concentric circle. As a result, if three or more ring-shaped flange structures are formed on the concentric circle, the connection points to the collector plate are formed unevenly in the longitudinal direction of the electrode plate.

On the other hand, in the battery according to the present invention, two or less ring-shaped flange structures are formed on each concentric circle. Therefore, the connection points can be distributed evenly, not like the above-described connection points. Accordingly, the battery with low internal resistance and high efficiency can be realized.

In the viewpoint of evenly distributing the ring-shaped flange structures, it is preferable that the number of the ring-shaped flange structures formed on each concentric circle is one, if possible. However, even if the number of the ring-shaped flange structures formed on each concentric circle is two, it is substantially possible to evenly distribute the connection points in the longitudinal direction of the electrode plate by forming the ring-shaped flange structures so as to be symmetric with respect to the center line of the connection area on the collector plate, or symmetric with respect to the center point of the connection area. The collector plate can be easily designed by forming the ring-shaped flange structures so as to be symmetric with respect to the line of the point. As a result, the production cost can be reduced.

In the battery according to the present invention, the collector plate having the above-described structure may be used as the positive collector plate, or the negative collector plate. In both cases, the above-described effects can be gained.

Also, in the battery according to the present invention, the flange shape of the each ring-shaped flange structure may be circular or oval. The flange shape of the linear flange structure may be straight or curved, such as in wave shape. Further, each semi ring-shaped flange structure is required to have the partially cut out flange, however the percentage of the cut out part can be arbitrarily determined.

### BRIEF DESCRIPTION OF THE DRAWINGS

These and the other objects, advantages and features of the invention will become apparent from the following description thereof taken in conjunction with the accompanying drawings which illustrate a specific embodiment of the invention. In the drawings:

FIG. 1 is a partial sectional view of a battery 1 according to an embodiment of the present invention;

FIG. 2 is a perspective view showing a structure of a positive collector plate 15;

FIG. 3A is a plan view of a positive collector plate 15;

FIG. 3B is a partial sectional view of a positive collector plate 15;

FIG. 3C is a partial sectional view of a positive collector plate 15;

FIG. 3D is a partial sectional view of a positive collector plate 15;

FIG. 4 is a schematic plan view of a positive collector plate 15, showing locations of ring-shaped flange structures 152;

FIG. 5A is a plan view showing a positive collector plate 55 according to a practical example;

FIG. 5B is a plan view showing a positive collector plate 65 according to a comparative example 1;

FIG. 5C is a plan view showing a positive collector plate 75 according to a comparative example 2; and

FIG. 6 is a plan view showing a negative collector plate 56 included in a battery according to a modification.

### DESCRIPTION OF THE PREFERRED EMBODIMENT

The following describes a preferred embodiment of the present invention based on a cylindrical battery 1 (hereinafter simply called “the battery 1”) as an example, with reference to the drawings. Note that the embodiment shows only an example, and the present invention is not limited to the embodiment.

Overall Structure of Battery 1

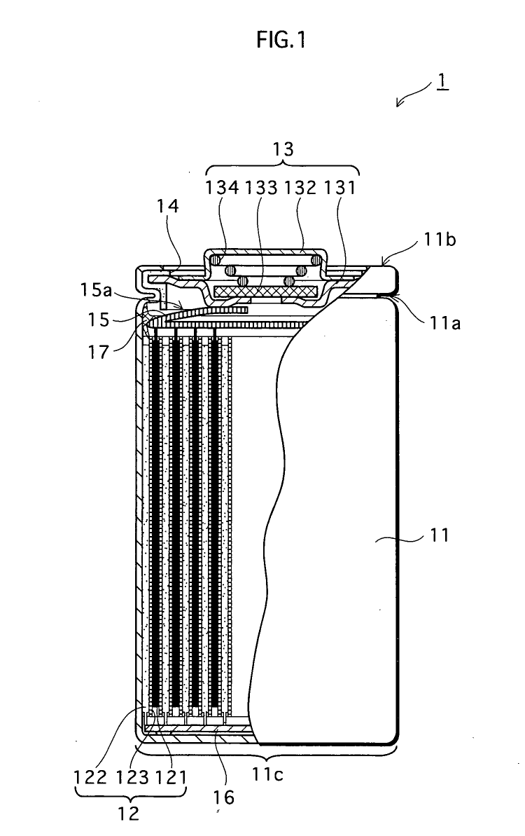

The following describes an overall structure of a battery 1 according to the present invention, with reference to FIG. 1.

As FIG. 1 shows, an electrode assembly 12, which includes a positive electrode plate 121, a negative electrode plate 122 and a separator 123, is housed in a casing 11, and the opening of the casing 11 is sealed by a seal cover 13. The seal cover 13 is placed on a wall of a groove 11a that is formed in a part of the casing 11, and fixed to the casing 11 by caulking a rim 11b of the opening of the casing 11 so that a gasket 14 is inserted between the seal cover 13 and the casing 11.

The casing 11 is a cylinder with a closed bottom, and made mostly from a steel sheet to which a nickel coating is applied.

The electrode assembly 12 is formed by spirally winding a positive electrode plate 121 and a negative electrode plate 122 that sandwich a separator 123. Here, the positive electrode plate 121 is, for instance, structured by forming a sintered nickel porous material on the surface of a core part that is made from a punching metal for instance, and then filling an active material mainly constituted of nickel hydroxide into the positive electrode plate 121 by a chemical impregnation method. The negative electrode plate 122 is, for instance, structured by forming a sintered cadmium porous material on the surface of a core part that is made from a punching metal for instance, and then filling an active material mainly constituted of cadmium hydroxide into the negative electrode plate 122 by the chemical impregnation method.

As FIG. 1 shows, the core part of the positive electrode plate 121 is exposed above the electrode assembly 12. In other words, the positive electrode plate 121 is extended toward the seal cover 13. The core part of the negative electrode plate 122 is exposed below the electrode assembly 12. In other words, the negative electrode plate 122 is extended toward the bottom of the casing 11. On the both end surfaces of the electrode assembly 12, a positive collector plate 15 is connected to the edge of the core part of the positive electrode plate 121, and a negative collector plate 16 is connected to the edge of the core part of the negative electrode plate 122.

The positive collector plate 15 includes a lead area 15a that is in a shape of a rectangle. The positive collector plate 15 is connected to the seal cover 13 at the lead area 15a. The structure of the positive collector plate 15 is described later.

The negative collector plate 16 has a projection (not illustrated) that projects toward the casing 11. The negative collector plate 16 is connected to the bottom 11c of the casing 11 at the-projection. Here, a tongue-shaped welding area may be formed on the substantial center of the negative collector plate 16 instead of the projection, and the welding area and the bottom 11c of the casing 11 may be connected by resistance welding before placing the seal cover 13.

Each of the positive collector plate 15 and the negative collector plate 16 are formed with use of a metal sheet (e.g. a steel sheet to which a nickel coating is applied, having thickness of 0.2 to 0.4 mm).

The seal cover 13 includes a cover plate 131 in a shape of a shallow dish and a cap 132, which are disposed so as to oppose each other, and a valve plate 133 and a spring 134 are housed in the space formed between the cover plate 131 and the cap 132. Normally, the valve plate 133 is pressed against the cover plate 131 so as not form any space. If the inside pressure of the battery 1 reaches a predetermined value, the valve plate 133 is to be pressed up toward the cap 132 to reduce the internal pressure.

As FIG. 1 shows, an insulating washer 17 is inserted between the positive collector plate 15 and the inside surface of the casing 11. The insulating washer 17 is made from an insulating resin, and insulates the positive collector plate 15 from the inside surface of the casing 11, and insulates the positive electrode plate 121 of the electrode assembly 12 from the inside surface of the casing 11. The insulating washer 17 also prevents the electrode assembly 12 from moving in the casing 11 when a vibration is applied from outside the battery 1.

Although not illustrated in FIG. 1, electrolyte is filled in the casing 11 with the electrode assembly 12 and so on.

Structure of Positive Collector Plate 15

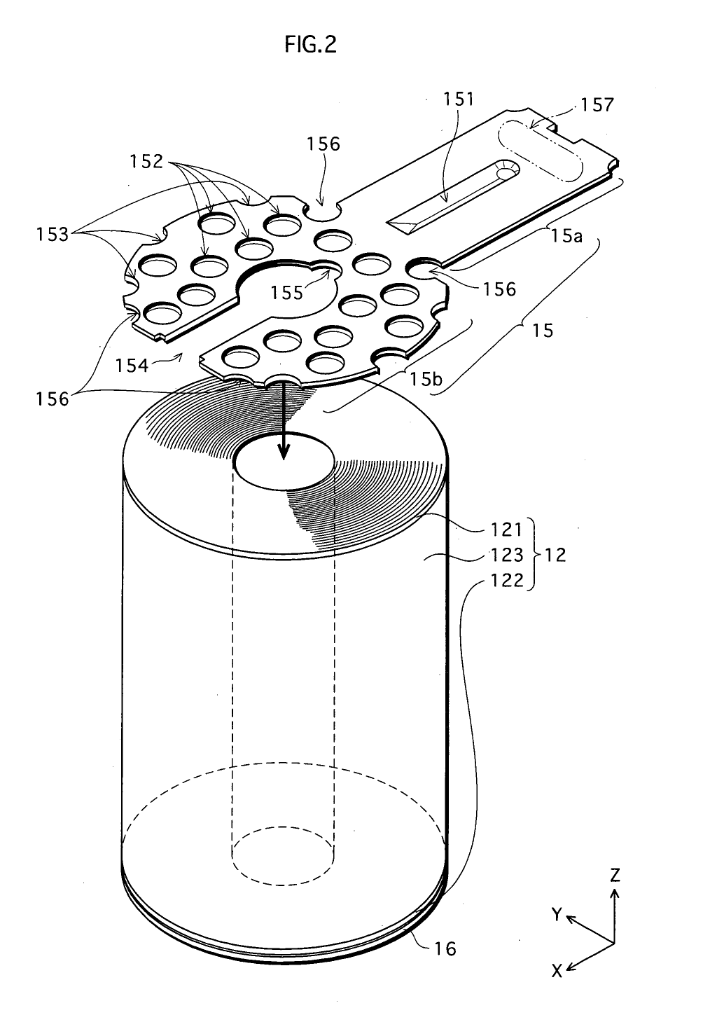

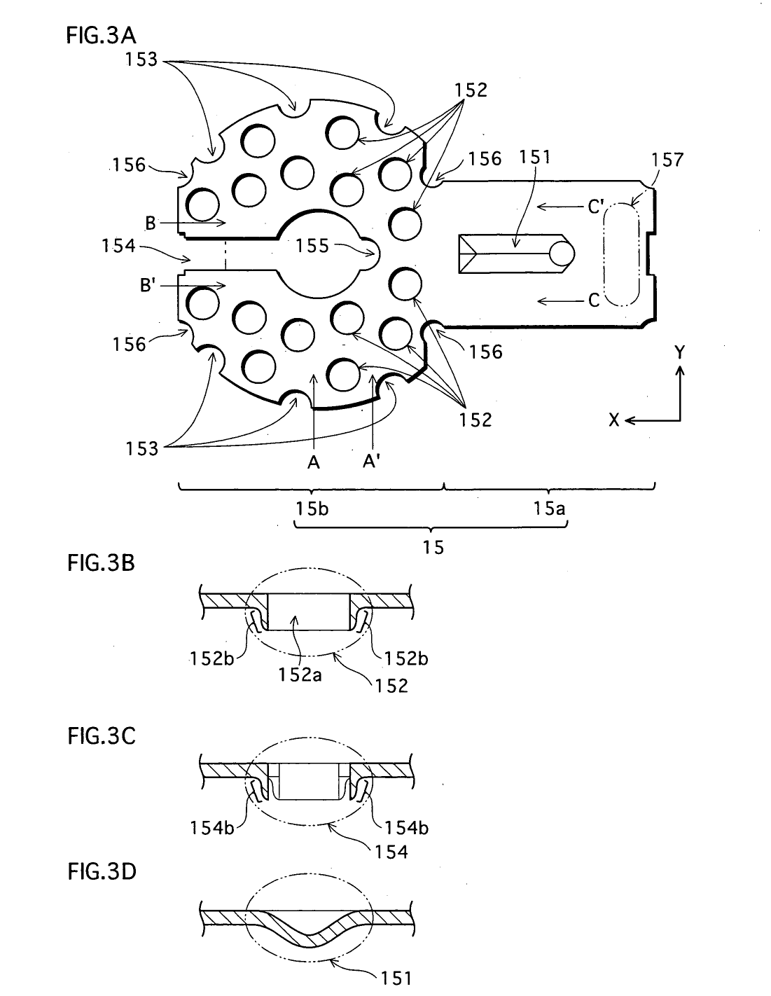

The structure of the positive collector plate 15, which is the most characteristic part of the battery 1 according to the embodiment, is described next with reference to FIG. 2 and FIG. 3A to FIG. 3D.

As FIG. 2 shows, the core part of the positive electrode plate 121 is exposed at the top end surface of the electrode assembly 12, and the core part of the negative electrode plate 122 is exposed at the bottom end surface of the electrode assembly 12. The collector plate 15 is connected to the top end surface of the electrode assembly 12 by the resistance welding, and the negative collector plate 16 is connected to the bottom end surface also by the resistance welding.

As FIG. 2 shows, the positive collector plate 15 mainly includes the lead area 15a for the connection to the seal cover 13, and a connection area 15b for the connection to the electrode assembly 12. The connection area 15b is substantially in a circular shape on the XY plane, and the lead area 15a is a rectangular area extended from a part of the edge of the connection area 15b in the X direction.

The lead area 15a has, on the main surface thereof, a depression part 151 that is depressed downward in the Z direction and extended in the X direction. After the positive collector plate 15 is connected to the electrode assembly 12 and when they are housed in the casing 11, the lead area 15a is to be fold back along the border between the lead area 15a and the connection area 15b. This means that the depression part 151 of the lead area 15a is to be turned over, and the bottom of the depression part 151 touches the cover plate 131 of the seal cover 13 that is placed on the positive collector plate 15. Also, a flat part 157 is formed behind the depression part 151 of the lead area 15a.

Flange structures 152 to 155, respectively having four different shapes, are formed on the connection area 15a.

A through hole that is substantially in a circular shape in the XY plane view is formed on the substantial center of the main surface of the connection area 15b. Also, ring-shaped flange structures 152a, each having a flange 152b (see FIG. 3B) projecting downward in the Z direction, are formed on the main surface of the connection area 15b. The flange 152b is formed so as to adjoin the through hole, and have a closed-ring shape.

Semi ring-shaped flange structures 153, each having a semi ring shape where the circumference of the flange is partially cut out, are formed on the outer edge of the main surface of the connection area 15b. In the flange structures 153, a flange is formed so as to adjoin the hole as well, and have an opened-ring shape, where the circumference of the flange is partially cut out, on the outer circumference of the connection area 15b.

Also, on the main surface of the connection area 15b, linear flange structure 154 is formed so as to extend in the X direction from the through hole on the center part, and have an opening at the end on the positive collector plate 15.

Further, a semi ring-shaped inner flange structure 155 is formed on the edge of the connection area 15b, which adjoins the through hole. The semi ring-shaped inner flange structure 155 has the same structure as each of the above-described semi ring-shaped flange structures 153 formed on the outer edge of the connection area 15b. The flange of the semi ring-shaped inner flange structure 155 is cut out at the circumference of the through hole, and therefore the semi ring-shaped inner flange structure 155 has an opened-ring shape.

As FIG. 2 shows, in addition to the above-described flange structures 152 to 155, cut-out structures 156 used for positioning are formed at four regions on the main surface of the connection area 15b. The four cut-out structures 156 are used as guides on the XY plane for positioning the positive collector plate 15 on the electrode assembly 12. Note that a flange may be formed on the edge of each cut-out structure that adjoins the opening, for contributing to the connection to the positive electrode plate 121.

Regarding the positive collector plate 15 included in the battery 1 according to the embodiment, the four types of flange structures 152 to 155 are formed on the main surface of the connection area 15b as FIG. 3A shows, and all the flange structures respectively have flanges that project toward the electrode assembly 12, such as the flange 152b and the flange 154b, as FIG. 3B and FIG. 3C show. Here, each of the semi ring-shaped flange structures 153 and the semi ring-shaped inner flange structure 155 has the similar flange. However, the flange is not illustrated, because it is the same as the other flanges apart from the shape, which is the opened-ring shape or the closed-ring shape.

As FIG. 3B shows, each ring-shaped flange structure 152 has a circular hole 152a and the flange 152b adjoining the hole. As described above, each of the semi ring-shaped flange structures 153 and the semi ring-shaped inner flange structure 155 has the opened-ring shape where the flange is partially cut out. The structure is the same as each ring-shaped flange structure 152 as FIG. 3B shows apart from that the flange is in the semi ring shape formed by the cut-out.

As FIG. 3C shows, each linear flange structure 154 has a structure in which the flange 154b is formed around a slit so as to adjoin the slit. Note that the height in the Z direction of each of the flanges 152b and 154b, included in the flange structures 152 to 154, is approximately 0.3 to 0.8 (mm).

How to form the flange structures is not described here because it is publicly known. However, note that the tip of each flange is shaped to be sharp in order to ensure high weldability to the positive electrode plate 121.

The depression part 151 that is formed in the lead area 15a on the positive collector plate 15 is extended in the X direction so a to be a triangular depression as FIG. 3D shows.

Connection Between Seal Cover 13 and Positive Collector Plate 15, and Connection Between Casing 11 and Negative Collector Plate 16

Using the four cut-out structures 156, the above-described positive collector plate 15 is to be placed on the end surface of the electrode assembly 12, on which the core part of the positive electrode plate 121 is exposed. Then, the positive collector plate 15 is to be connected to the end surface by the resistance welding. Although it is not described in detail here, the negative collector plate 16 has flange structures as well, and it is to be connected to the core part of the negative electrode plate 122 by the resistance welding.

The electrode assembly 12, to which the positive collector plate 15 and the negative collector plate 16 are connected, is to be housed in the casing 11, when the lead area 15a of the positive collector plate 15 is fold back approximately 150 to 180(°). After that, the groove 11a is formed in the vicinity of the opening of the casing 11, and the seal cover 13 is placed on the wall of the groove 11a. Here, in the casing 11, the inner surface of the seal cover 13 and the bottom of the depression part 151 formed on the lead area 15a of the positive collector plate 15 have a point contact or a line contact with each other. Note that the casing 11 has been filled with a predetermined amount of electrolyte, and the insulating washer 17 (see FIG. 1) has been inserted between the positive collector plate 15 and the seal cover 13, before the seal cover 13 is placed.

After the above-described preparation, a welding current is applied between the outer surface of the cap 132 included in the seal cover 13 and the bottom 11c of the casing 11, while applying a predetermined pressure to each of them. Accordingly, the positive collector plate 15 and the seal cover 13, and the negative collector plate 16 and the casing 11 are respectively connected to each other.

Note that the positive collector plate 15 included in the battery 1 according to the present invention has a flat part 157 in the lead area 15a as FIG. 3A to FIG. 3D show. The flat part 157 is formed to make it possible to previously insert a welding electrode and perform welding between the negative collector plate 16 and the casing 11 after the electrode assembly 12 is housed in the casing 11, and previously apply, outside the casing 11, resistance welding to the seal cover 13 and the positive collector plate 15, instead of performing the above-described connection method. In other words, the flat part 157, which is extended from the lead area 15a, is necessary in order to previously apply a resistance welding to the positive collector plate 15 and the seal cover 13 outside the casing 11, instead of connecting the positive collector plate 15 and the seal cover 13, and the negative collector plate 16 and the casing 11 at the same time just as in the battery 1 according to the embodiment. As described above, the positive collector plate 15 according to the embodiment is suitable for such different manufacturing methods.

If the manufacturing method is limited to the one that connects the positive collector plate 15 and the seal cover 13, and the negative collector plate 16 and the casing at the same time, the flat part 157 on the lead area 15a can be omitted because it is not necessary. If omitted, a lighter and smaller collector plate can be manufactured at low cost.

Configuration of Ring-Shaped Flange Structures on Positive Collector Plate 15

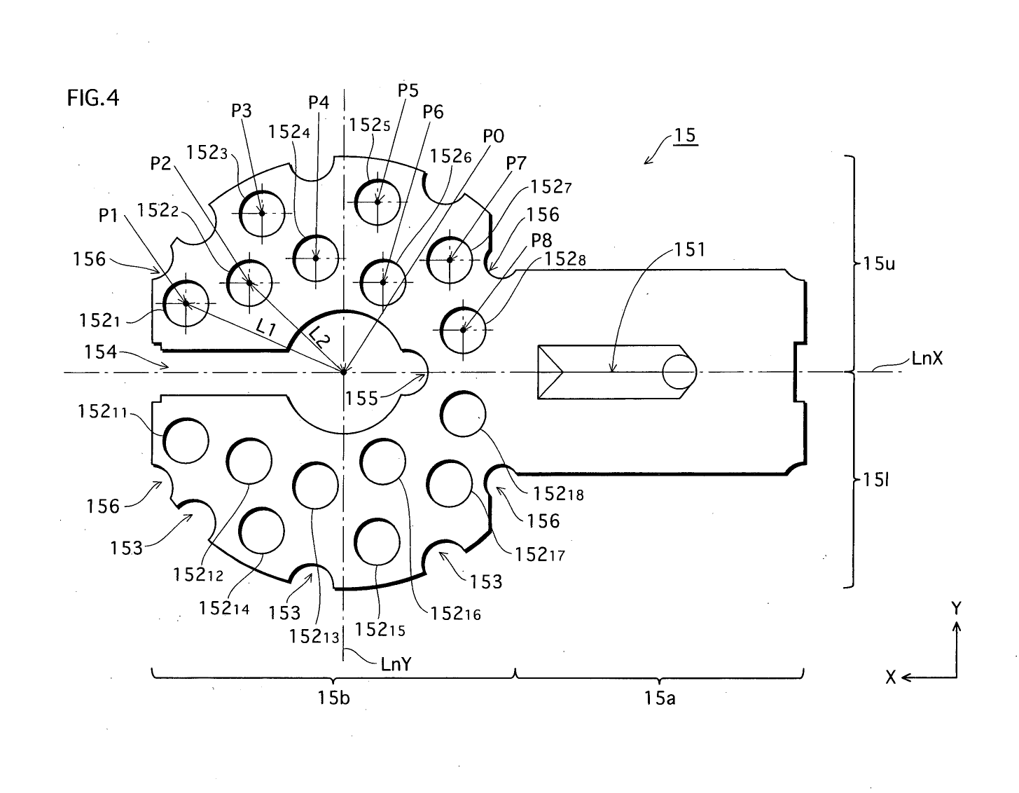

In the battery 1 according to the embodiment, among the flange structures 152 to 155 on the positive collector plate 15, the configuration of the ring-shaped flange structures 152 is optimized from the viewpoint of evenly distributing the connection points with the positive electrode plate 121, which is described next with reference to FIG. 4.

As FIG. 4 shows, two axes Lnx and Lny are assumed here. The axes go through the center point of the connection area 15b of the positive collector plate 15, and they are extended in the X direction and the Y direction respectively. A point P0 is the center point of the connection area 15b, that is, the intersection point of the X axis Lnx and the Y axis Lny.

Under such an assumption, the ring-shaped flange structures 152 are formed on the positive collector plate 15 so as to be symmetric in an area 15u and an area 151, which are respectively the upper and lower side of the X axis Lnx. In other words, the flange structure 152₁ is symmetric with respective to the flange structure 152₁₁, and the flange structures 152₂ to 152₈ are symmetric with respective to the flange structures 152₁₂ to 152₁₈ respectively. The following describes only the upper side of the X axis Lnx in FIG. 4.

As FIG. 4 shows, points P1 to P8 are the center points of the ring-shaped flange structures 152₁ to 152₈, and lines L1 to L8 (only L1 and L2 are illustrated) respectively indicate the linear distances between the point P0 and the points P1 to P8. On the positive collector plate 15, the ring-shaped flange structures 152₁ to 152₈ are formed so that all the distances L1 to L8 from the point P0 are different from each other.

Here, the ring-shaped flange structures 152 are formed on the positive collector plate 15 so as to be in symmetry with respect to the X axis Lnx. Accordingly, two ring-shaped flange structures 152 are formed on each concentric circle. Note that although the ring-shaped flange structures 152 are formed on the positive collector plate 15 so as to be in symmetry with respect to the X axis Lnx in this embodiment, the configuration is not limited to such a symmetric form, and it can be determined depending on the case. However, it is preferable not forming three of more ring-shaped flange structures 152 on each concentric circle having the center point P0. The reason is described later.

As FIG. 4 shows, the linear flange structure 154 is formed on the positive collector plate 15 so as to extend in the X direction. The X direction is the same as the direction that the production line of the steel sheet flows. In the production line, the steel sheet, which is strip-shaped material of the positive collector plate 15, is wound around a reel and used for a hoop processing.

Advantages of Battery 1

The positive collector plate 15 included in the battery 1 according to the embodiment has the following three characteristics with regard to its structure.
(1) The positive collector plate 15 includes ring-shaped flange structures 152 and the linear flange structure 154, and further includes the semi ring-shaped flange structures 153 as well.
(2) On the positive collector plate 15, not more than two ring-shaped flange structures 152 are formed on each concentric circle around the center point P0.
(3) The linear flange structure 154 is formed on the positive collector plate 15 so as to extend in the X direction that is the same as the direction that the works flow at the time of the hoop processing.

The advantages provided by the characteristics are described next.

Firstly, in the positive collector plate 15 of the battery 1 according to the embodiment with the characteristic structure described in (1), the distribution density of the connection points, which are formed on the positive electrode plate 121 included in the electrode assembly 12, can be even in the longitudinal direction. The positive collector plate 15 is surely connected to the whole wound positive electrode plate 121 by the linear flange structure 154, and the ring-shaped flange structures 152 make connection points between adjoining connection points formed by the linear flange structure 154. With the combination of the two types of the flange structures 152 and 154, the connection points are evenly distributed in the longitudinal direction of the positive electrode plate 121.

Next, in the positive collector plate 15 of the battery 1 according to the embodiment with the characteristic structure described in (2), in synergy with the advantage provided by the characteristic structure described in (1), the connection points can be evenly distributed in the longitudinal direction of the positive electrode plate 121, and this lower the internal resistance of the battery 1 and realizes an efficient battery. Here, if three or more ring-shaped flange structures are formed on the positive collector plate, the connection points to the positive collector plate are made in three or more areas that adjoin each other in the longitudinal direction of the positive electrode plate. Also, a certain distance is required between the adjoining ring-shaped flange structures on the positive collector plate from the view point of the electrical resistance and the structural strength. Therefore, other ring-shaped flange structures are required to be formed at a certain distance away from the three or more ring-shaped flange structures on each concentric circle. This means that if three or more ring-shaped flange structures are formed on each concentric circle, the connection points to the positive collector plate are unevenly distributed in the longitudinal direction of the positive electrode plate.

On the other hand, the connection points are evenly distributed on the positive collector plate 15 of the battery 1 according to the embodiment because of the structure described in (2). This realizes the battery with high efficiency and low internal resistance.

Next, with the characteristic structure described in (3), in the case where the hoop processing the processing is performed for forming the flange structures 152 to 154 and so on during the manufacturing process, the linear flange structure 154 are not formed in the direction that intersects with the direction that the production line flows. Therefore, the strength of the positive collector plate 15 according to the embodiment is not to be deteriorated. Also, the linear flange structure 154 has the flange 154b that forms approximately 90° with the direction of the main surface of the positive collector plate 15. This functions as reinforcement for the plate around the flange 154b. Accordingly, the positive collector plate 15 with high structural strength and high dimensional accuracy can be manufactured. Such a positive collector plate 15 having high dimensional accuracy also contributes to the defect reduction.

As described above, the battery 1 according to the embodiment has a positive collector plate 15 that has advantageous structural characteristics described in (1) to (3). Therefore, in the battery 1, it is easy to evenly distribute the connection points to the positive collector plate 15 in the direction of the positive electrode plate 121, and increase the number of the connection points. As a result, the battery 1 with low internal resistance and high efficiency can be realized.

Further, in the battery 1 according to the embodiment, the semi ring-shaped flange structures 153 and the semi ring-shaped inner flange structure 155 are formed in the connection area 15b of the positive collector plate 15 in addition to the two types of the flange structures, namely the flange structure 152 and the flange structure 154. This makes it possible to secure more connection points between the positive collector plate 15 and the positive electrode plate 121 included in the electrode assembly 12. As a result, the battery 1 with low internal resistance and high efficiency can be realized.

Experiments for Confirming the Advantages

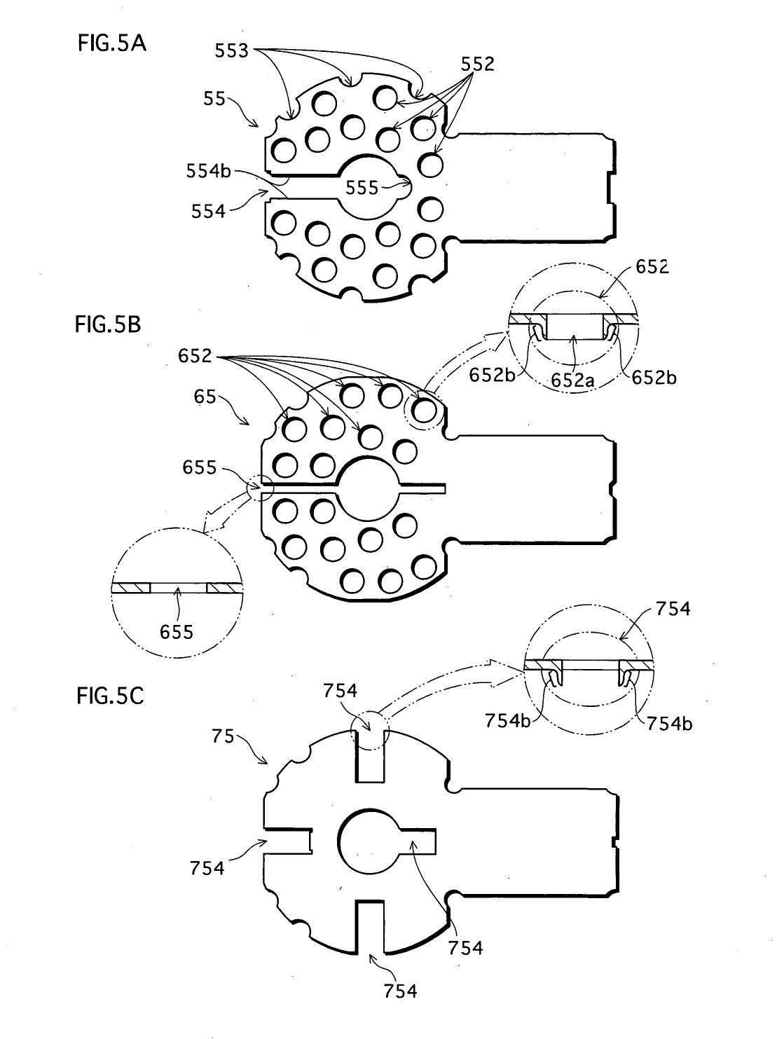

Experiments performed for confirming the above-described advantages are described next with reference to FIG. 5A to FIG. 5C. FIG. 5A is a plan view of a positive collector plate 55 according to a practical example. FIG. 5B is a plan view of a positive collector plate 65 according to a comparative example 1. FIG. C is a plan view of a positive collector plate 75 according to a comparative example 2.
(1-1) Practical Example

The positive collector plate 55 according to the practical example has the same structure as the above-described positive collector plate 15 of the battery 1. As the practical example, an SC size cylindrical nickel-cadmium (Ni—Cd) battery has been manufactured. The structure of this battery is the same as the above-described battery 1 as well. Regarding the connection area in the positive collector plate 55, the outside diameter is φ19.0 (mm), the inside diameter is φ5.5 (mm), the diameter of the opening of each ring-shaped flange structure 552 is φ2.0 (mm), and the width of a slit of a linear flange structure 554 is 2.0 (mm). The height of the flange included in each of the flange structures 552 to 555 is 0.55 (mm).
(1-2) Comparative Example 1

As FIG. 5B shows, the positive collector plate 65 according to the comparative example 1 is similar to the positive collector plate 55 according to the above-described practical example in that the positive collector plate 65 has ring-shaped flange structures 652. However, the positive collector plate 65 does not have the linear flange structure, the semi ring-shaped flange structures, the semi ring-shaped inner flange structure, and so on, and instead has a slit for suppressing a reactive current caused when the resistance welding is performed. In other words, as the enlarged drawings in FIG. 5B show, although a flange 652b is formed in each ring-shaped flange structure 652 so as to adjoin an opening 652a just as the above-described practical example, the slit 655 does not have a flange.

On the positive collector plate 65 according to the comparative example 1, three or more ring-shaped flange structures 652 are formed on each concentric circle with respect to the center point of the connection area. The size of each ring-shaped flange structure 652 is the same as in the positive collector plate 55 of the above-described practical example.

The battery according to the comparative example 1 includes the same components as the battery according to the practical example except for the positive collector plate 65.

Note that the semicircular openings formed on the outer edge of the connection area are the counter parts of the cut-out structures 156 of the positive collector plate 15 according to the above-described embodiment, and they are not flange structures.
(1-3) Comparative Example 2

As FIG. 5C shows, although the positive collector plate 75 according to the comparative example 2 has four linear flange structures 754, it is different from the collector plate 55 according to the above-described practical example in that the positive collector plate 75 does not have ring-shaped flange structures, semi ring-shaped flange structures, and semi ring-shaped inner flange structures. Regarding the structure of the linear flange structure 754, both edges of the slip project toward the connection assembly, and the flange 754b is thereby formed as the enlarged drawing in FIG. 5C shows. Also in the comparative example 2, the height of the flange 754b of each linear flange structure and so on are the same as the positive collector plate 55 of the above-described practical example.

The battery according to the comparative example 2 includes the same components as the battery according to the practical example and the comparative example except for the positive collector plate 75.

Note that the semicircular openings formed on the outer edge of the connection area are the counterparts of the cut-out structures 156 of the positive collector plate 15 according to the above-described embodiment, just as the above-described comparative example 1.
(2) Evaluation

The following confirmation has been performed using the above-described three types of the battery.
(2-1) Confirm the numbers of connection points between each of the positive collector plate 55 to 57 and the positive electrode, and fill a Table.1 with index numbers, where the battery according to the comparative example 1 is given the index number of 100.
(2-2) Measure the internal resistances and fill the Table.1 with the measured values.

(2-3) Measure the operating voltages while the battery discharges a 40 (A) current.

| | Index Number | Internal | |
|---|---|---|---|
| | of Connection | Resistance of | Operating |
| | Points | Battery (mΩ) | Voltage (V) |
| Practical Example | 120 | 2.5 | 1.025 |
| Comparative Example 1 | 100 | 3.4 | 0.999 |
| Comparative Example 2 | 75 | 4.8 | 0.985 |

The comparative example 1 is given the index number of 100.

As Table.1 shows, regarding the positive collector plate 55 according to the practical example 1, in which the connection points are formed by the combination of the ring-shaped flange structures 552, the semi ring-shaped flange structures 553, and the linear flange structure 554, and two or less ring-shaped flange structures 552 are formed on each concentric circle as described above, the number of the connection points is 20(%) increased from the number of the connection points of the comparative example 1, and as much as 60(%) increased from the number of the connection points of the comparative example 2. Here, the semi ring-shaped flange structures and the semi ring-shaped inner flange structures (which are not given any signs in FIG. 5A, but have the same structure as those of the positive collector plate 15) also contribute to the advantage of the number of the connection points of the positive collector plate 55 according to the practical example.

The internal resistances of the battery according to the practical example, the battery according to the comparative example, and the battery according to the comparative example 2 are 2.5 (mQ), 3.4 (mQ) and 4.8 (mQ) respectively. This means that in the battery according to the practical example, the internal resistance can be reduced by 36(%) compared to the battery according to the comparative example 1, and it can be reduced by 92(%) compared to the battery according to the comparative example 2.

Further, as Table.1 shows, the operating voltage is 1.025 (V) in the battery according to the practical example. This means that the operating voltage can be increased by 0.026 (V) and 0.040 (V) compared to 0.999 (V) of the battery according to the comparative example 1 and the 0.985 (V) of the battery according to the comparative example 2 respectively.

The result proves that with the positive collector plate 55 having the structure shown in FIG. 5A, the battery according to the practical example can increase the number of connection points between the positive collector plate 55 and the positive electrode plate compared to the comparative examples 1 and 2, and this reduces the internal resistance. Also, this enables the battery according to the practical example to gain higher operating voltage compared to the comparative examples 1 and 2. Therefore, the battery according to the practical example is a highly efficient battery overall. Further, with the above-described characteristics, the battery according to the practical example is suitable for use as a power source of an electric tool and so on which use large currents at a time.

Modification

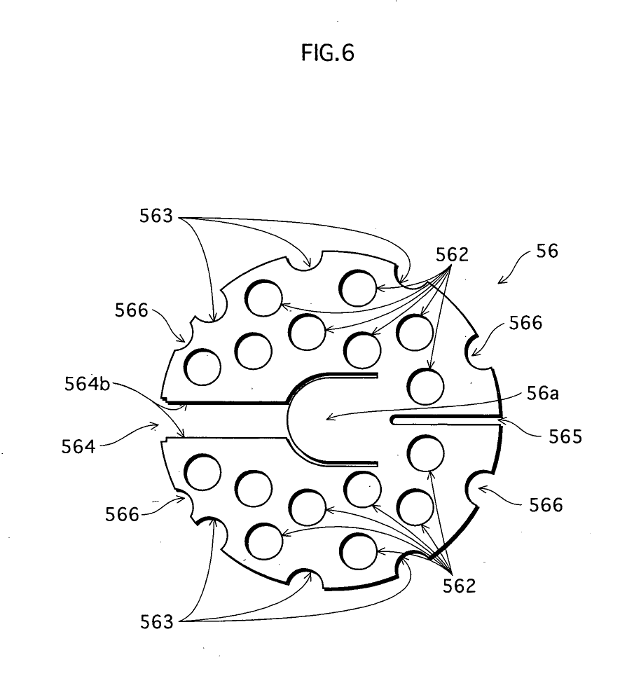

A battery according to a modification is described next with reference to FIG. 6. FIG. 6 is a plan view showing a negative collector plate 56 included in the battery according to the modification.

The battery according to the modification is mainly different from the above-described battery 1 in the structure of the negative collector plate 56. The following mainly describes the difference.

As FIG. 6 shows, the negative collector plate 56 has a substantially circular main surface, and a tongue-shaped connection part 56a is formed on the center portion of the main surface. Ring-shaped flange structures 562, semi ring-shaped flange structures 563, and a linear flange structure 564 are formed on the main surface of the negative collector plate 56 except for the connection part 56a. Each of the flange structures 562 to 564 has the same structure as each of the flange structures 152 to 154 of the positive collector plate 15 included in the above-described battery 1.

The main surface of the negative collector plate 56 also has a slit 565 for suppressing a reactive current caused when the resistance welding is performed. Further, in the same manner as the above-described positive collector plate 15, a cut-out structure 556, which is used for positioning the negative collector plate 56 on the electrode assembly 12, is formed on the outer edge of the negative collector plate 56. Here, it is possible to form a flange on the edge of the cut-out structure 556 as well so that the cut-out structure 556 contributes to the connection to the negative collector plate 122.

For manufacturing a battery using the negative collector plate 56, firstly the positive collector plate and the negative collector plate 56 are attached to the electrode assembly by the resistance welding, and then the electrode assembly is housed in the casing. After that, the connection part 56a on the collector plate 56 is connected to the bottom of the casing by the passage of a current that is applied to the connection part 56a from a welding electrode that is put through the spiral axis of the electrode assembly and pressed against the connection part 56a. Then, the seal cover is placed over the opening of the casing to connect the positive collector plate to the closure cap. Finally, the manufacturing process is completed by caulking the rim of the opening of the casing.

In the battery having the negative collector plate 56 according to the modification, the connection points between the negative collector plate 56 and the negative electrode plate can be evenly distributed as well as the connection points between the positive collector plate 15 and the positive electrode plate 121. Also, by optimally distributing the ring-shaped flange structures 562, the number of the connection points can be increased compared to the case where the conventional collector plate is used. Therefore, in the battery having the negative collector plate 56, it becomes possible to decrease the internal resistance and gain higher operating voltage.

Although not mentioned above, the positive collector plate 15 may be used as the positive collector plate in the modification, or another positive collector plate may be used as well.

Supplementary Explanations

In the above-described embodiment and modification, the Ni—Cd battery is used as an example battery. However, the present invention is applicable to other batteries. For instance, the present invention is applicable to alkaline batteries, such as nickel-hydrogen batteries, and nonaqueous batteries, such as lithium-ion batteries, to gain the same advantageous effects. Also in the above-described embodiment and modification, the spiral structure is used as an example structure of the electrode assembly 12. However, a stack structure or the like, in which the positive electrode plate and the negative electrode plate are layered so as to sandwich the separator, may be used.

The number and the location of each of the flange structures 152 to 155 and 562 to 564 can be modified as long as the structural characteristics of the present invention are realized. For instance, the number and the location of each of the ring-shaped flange structures 152 and 562 can be changed to optimal values according to the size of the battery and the size of the electrode assembly and so on.

In the above-described embodiment and modification, the shape of the opening of each of the ring-shaped flange structures 152 and 562 is substantially circular. However, the shape is not limited to this, and it may be rectangular, oval, and so on. Also, the slit of each of the linear flange structures 154 and 564 are not necessarily linear, and it may be corrugated and so on.

In the above-described embodiment and modification, the semi ring-shaped flange structures 153 and 563, and the semi ring-shaped inner flange structure 155 are respectively formed on the collector plate 15 and 56 in addition to the ring-shaped flange structures 152 and 562, linear flange structures 154 and 564. However, they are not always necessary. Note, however, that it is preferable to form such flange structures from the viewpoint of securing many connection points to the electrode plate.

The numerical values and materials in the above-described embodiment are specified for clarify the structural characteristics of the present invention. The present invention is not limited by those particular values and materials.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A battery comprising:
an electrode assembly that includes a positive electrode plate and a negative electrode plate opposing each other across a separator;
a casing that is in a shape of a cylinder with a closed bottom, the electrode assembly being housed in the casing;
a seal cover that is placed over an opening of the casing, the opening being sealed by the seal cover; and
a collector plate having a connection area and being housed in the casing together with the electrode assembly, wherein
the connection area includes flange structures, each having a flange that projects toward the electrode assembly and connecting the collector plate to an edge of the positive electrode plate or an edge of the negative electrode plate, and
the flange structures include a ring-shaped flange structure whose flange is formed along an edge of a hole, and a linear flange structure whose flange is formed along edges of a slit.

2. The battery of claim 1, wherein
the flange structures further include semi ring-shaped flange structures, each having a flange that is formed along an edge of an opening, and being formed such that a portion of an outer edge of the connection area is removed.

3. The battery of claim 1, wherein
a through hole is formed on a center of the connection area, and
the flange structures further include a semi ring-shaped inner flange structure, having a-flange that is formed along an edge of an opening, and being formed such that a portion of an edge of the through hole is removed.

4. The battery of claim 1, wherein
the electrode assembly has a structure in which the positive electrode plate and the negative electrode plate are spirally wound together, and the edge of the positive electrode plate and the edge of the negative electrode plate are respectively exposed at one end surface of the electrode assembly and the other end surface of the electrode assembly,
the connection area is circular and corresponds in shape to the one end surface of the electrode assembly or the other end surface of the electrode assembly,
the collector plate is connected to the electrode assembly by aligning the center of the connection area with the center of the one end surface of the electrode assembly or the other end surface of the electrode assembly, and
the ring-shaped flange structure is one of a plurality of ring-shaped flange structures included in the connection area, and two or less ring-shaped flange structures are located on each concentric circle around a center point of the connection area.

5. The battery of claim 4, wherein
a tongue-shaped lead area is formed on the collector plate, the tongue-shaped lead area being extended, in a radial direction of the connection area, from a part of the outer edge of the connection area, and
the linear flange structure included in the connection area is extended in a same direction as the tongue-shaped lead area is extended.

6. The battery of claim 5, wherein
the slit of the linear flange structure is formed so as to extend, in a radial direction of the connection area, toward the center point of the connection area from an opposing part of an outer edge of the connection area, the opposing part opposing the part of the outer edge from which the tongue-shaped lead area is extended.

7. The battery of claim 5, wherein
the collector plate is placed within the casing so as to be sandwiched between the electrode assembly and the seal cover, the collector plate being connected to the seal cover with use of projections formed on the lead area.
